(19) United States
(12) Patent Application Publication
(10) Pub. No.: US 2011/0150270 A1
(43) Pub. Date: Jun. 23, 2011

(54) POSTAL PROCESSING INCLUDING VOICE TRAINING

(76) Inventors: Michael D. Carpenter, Arlington, TX (US); Dale E. Redford, Grand Prairie, TX (US)

(21) Appl. No.: 12/967,313

(22) Filed: Dec. 14, 2010

Related U.S. Application Data
(60) Provisional application No. 61/288,902, filed on Dec. 22, 2009.

(51) Int. Cl. G06K 9/00; G10L 17/00

(52) U.S. Cl. 382/101; 704/246; 704/E17.003

(57) ABSTRACT

System, methods, and apparatuses. A method includes receiving a voice input from a user, the voice input corresponding to printed information on a mail piece. The method includes performing a voice recognition process on the voice input to produce a voice address result, the voice recognition process using voice attributes from a database, and performing an optical character recognition process on an image of the printed information to produce recognized text and a confidence value. The method includes storing updated voice attributes corresponding to the voice input and recognized text in the database when the confidence value meets a first threshold, and combining the recognized text and the voice address result to produce a combined OCR result. The method includes sending the combined OCR result to a sorting system that sorts the mail piece according to the combined OCR result.

### CROSS-REFERENCE TO OTHER APPLICATION

This application claims the benefit of the filing date of U.S. Provisional Patent Application 61/288,902, filed Dec. 22, 2009, which is hereby incorporated by reference.

### TECHNICAL FIELD

The present disclosure is directed, in general, to voice recognition in postal processing systems.

### BACKGROUND OF THE DISCLOSURE

Improved postal processing and other systems are desirable.

### SUMMARY OF THE DISCLOSURE

Various disclosed embodiments include a system and method. A method includes receiving a voice input from a user, the voice input corresponding to printed information on a mail piece. The method includes performing a voice recognition process on the voice input to produce a voice address result, the voice recognition process using voice attributes from a database, and performing an optical character recognition process on an image of the printed information to produce recognized text and a confidence value. The method includes storing updated voice attributes corresponding to the voice input and recognized text in the database when the confidence value meets a first threshold, and combining the recognized text and the voice address result to produce a combined OCR result. The method includes sending the combined OCR result to a sorting system that sorts the mail piece according to the combined OCR result.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in which an embodiment can be implemented;

FIGS. 2-5 depict block diagram of voice recognition processes in accordance with disclosed embodiments; and

FIG. 6 depicts a flowchart of a process in accordance with disclosed embodiments.

### DETAILED DESCRIPTION

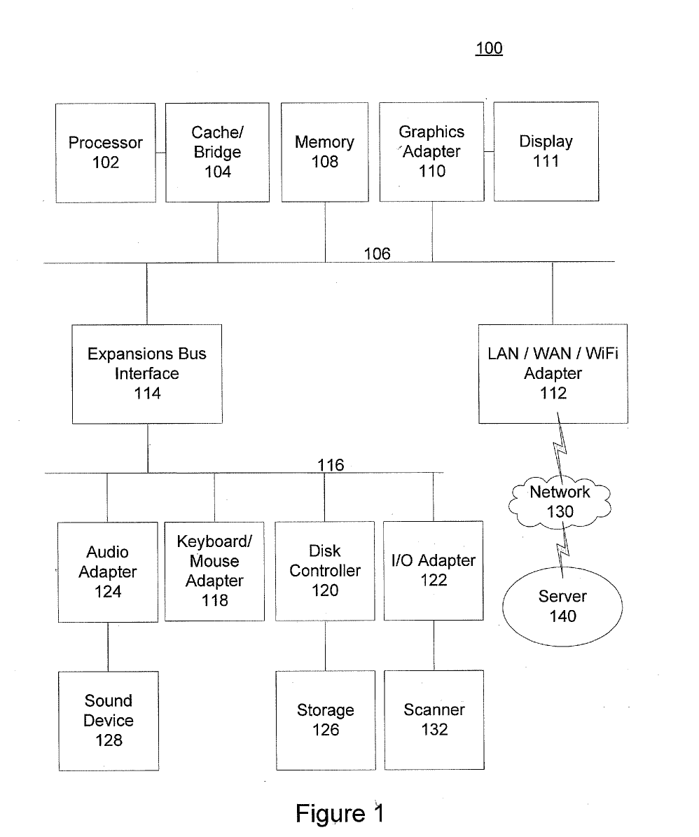

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Voice recognition is a means to identify data associated with an object such as the destination address of a mail piece like a parcel. This can be a more efficient means than having the operator enter the destination on a keyboard, especially if the operator is facing and placing the object because the operator's hands are free during voicing as opposed to a typing operation that requires at least one hand to enter the data.

Voice recognition and optical character recognition (OCR) processes can result in erroneous results. Disclosed embodiments include systems and methods that perform voice-recognition training functions at the same time as a mail sorting process or other mail processing process is performed.

FIG. 1 depicts a block diagram of a data processing system 100 in which an embodiment can be implemented, for example as a postal processing system including voice recognition, configured to perform processes as described herein. The data processing system 100 includes a processor 102 connected to a level two cache/bridge 104, which is connected in turn to a local system bus 106. The local system bus 106 may be, for example, a peripheral component interconnect (PCI) architecture bus. Also connected to the local system bus 106 in the depicted example are a main memory 108 and a graphics adapter 110. The graphics adapter 110 may be connected to a display 111.

Other peripherals, such as a local area network (LAN)/Wide Area Network/Wireless (e.g. WiFi) adapter 112, may also be connected to the local system bus 106. An expansion bus interface 114 connects the local system bus 106 to an input/output (I/O) bus 116. The I/O bus 116 is connected to a keyboard/mouse adapter 118, a disk controller 120, and an I/O adapter 122. The disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices. The I/O adapter 122 can be connected to any number of input/output devices, including in particular a scanner 132 that is capable of taking an image of a parcel, mail piece, or label for the OCR processes described herein.

Also connected to the I/O bus 116 in the example shown is an audio adapter 124, to which sound devices 128 are connected, including in particular a microphone for voice recognition processes. The keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. In some embodiments, multiple data processing systems may be connected and configured to cooperatively perform the processing described herein. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

The LAN/WAN/Wireless adapter 112 can be connected to a network 130 (not a part of data processing system 100), which can be any public or private data processing system network or combination of networks, as known to those of skill in the art, including the Internet. The data processing system 100 can communicate over the network 130 with a server system 140, which is also not part of the data processing system 100, but can be implemented, for example, as a separate data processing system 100.

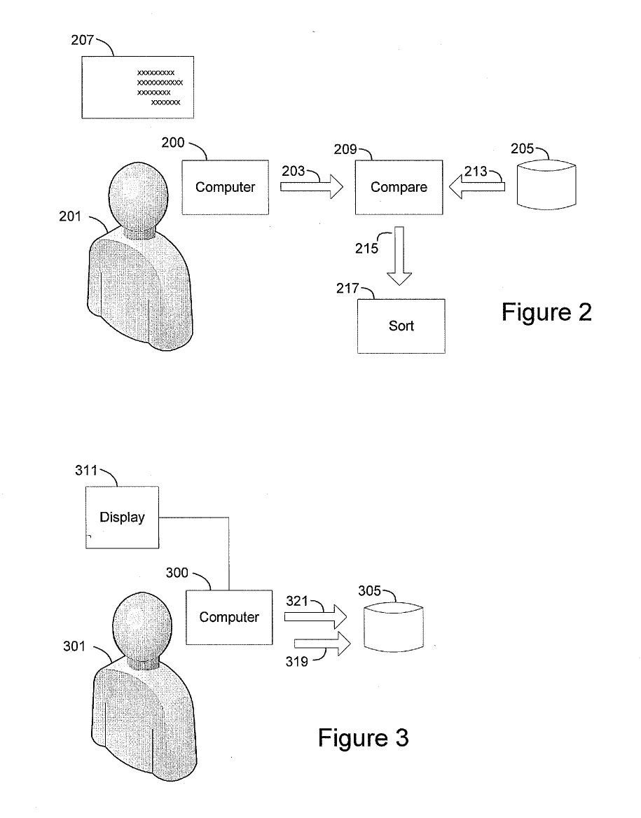

FIG. 2 depicts a block diagram of a basic voice recognition process. In this process, a user or operator 201 voices the address of object 207 into a microphone of a computer 200 that can be implemented as one or more data processing systems 100. The computer extracts various attributes from the captured audio signal. One method that can be employed for voice recognition is called the “Hidden Markov Model”. Using this or other methods, a pre-defined set of attributes is created for the lexicon of the application and stored in a database 205, that can be stored, for example, in a storage 126. The extracted voice attributes 203 are compared, by this or another data processing system 100, to these predefined generic attributes 213 and a best match is calculated, as illustrated by compare process 209, to produce address result 215. Typically a correlation value will be calculated that indicates how closely the voice attributes matched the pre-defined attributes. If the correlation value is above a pre-selected threshold value, the address result will be passed to the sort control 217 and the object will be sorted according to a sort plan. If the threshold value is not met the voice result is a reject and the object will be handled by an exception process.

One technique to improve the speech recognition performance and reduce errors is to train the system in advance to recognize speech from a particular operator.

FIG. 3 is a representation of a voice-recognition training process. The operators 301 are trained individually and database 305 of the lexicon is created with the measured attributes for each operator. To do this, the operator 301 is shown an image on display 311 that includes text and voices the text into a microphone of a computer 300 that can be implemented as one or more data processing systems 100. The system calculates user-specific voice attributes 321 for the various training values 319, and the user-specific voice attributes 321 and the training values 319 are stored in database 305, that can be stored, for example, in a storage 126. Database 305 can store voice attributes and training values for any number of users, along with other data. In such a process, the system must know what text is being read by the operator in order to compare the spoken words to the text to develop the training values. Such a system cannot work if the system does not know what text to which the spoken word is to be compared.

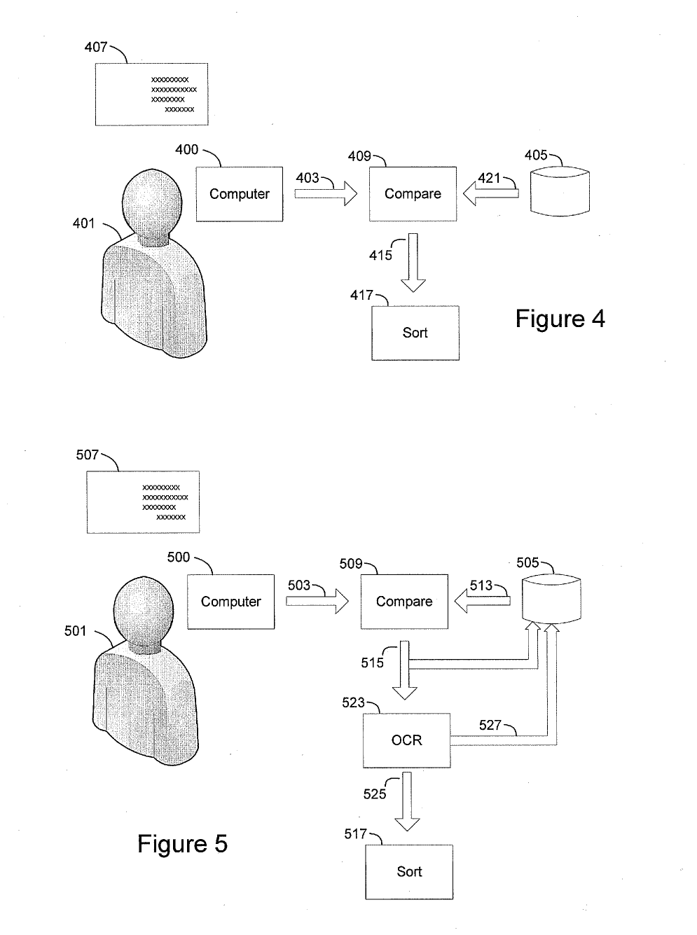

FIG. 4 depicts a block diagram of a basic voice recognition process after the attributes have been stored for an operator. Prior to beginning the recognition and sort operation, the operator 401 identifies her or himself to the system as operator “N”. The system then focuses the comparison 409 based on user attributes 421 in database 405 that were established for operator N during the training session illustrated in FIG. 3.

In this process, a user or operator 401 voices the address of object 407 into a microphone of a computer 400 that can be implemented as one or more data processing systems 100. The computer extracts various attributes from the captured audio signal. Using this or other methods, a pre-defined set of generic attributes is created for the lexicon of the application and stored in a database 405, that can be stored, for example, in a storage 126. The extracted voice attributes 403 are compared, by this or another data processing system 100, to the operator attributes 421 and a best match is calculated, as illustrated by compare process 409, to produce address result 415. Typically a correlation value will be calculated that indicates how closely the voice attributes matched the pre-defined attributes. If the correlation value is above a pre-selected threshold value, the address result will be passed to the sort control 417 and the object will be sorted according to a sort plan. If the threshold value is not met the voice result is rejected and the object will be handled by an exception process.

Because a typical lexicon has thousands of entries it is not practical to have the operator read every grammar item. One method to overcome this difficulty is to choose the training text such that the operator voices the phonemes that make up the words in the lexicon. The system then assembles the measured phoneme attributes to match the words based upon a known sequence of phonemes for each item. In a Hidden Markov Model this is known as the state sequence and large databases such as the National Science Foundation Gallery of the Spoken Word exist that may be used to define the sequences and other attributes for a given lexicon.

U.S. Pat. No. 7,590,537 to Kim, et al. hereby incorporated by reference, defines a method of developing a database that clusters speakers based upon dialects. These dialects vary based upon gender, ethnicity, region and other factors. A pre-recorded database based upon dialects can be used to determine general attributes such as the state sequences for spoken words. By using pre-defined attributes for the lexicon based on dialect, a much more robust system can be created, particularly when coupled with training as described herein.

US patent application 2009/0110284 of Lamprecht, et al., hereby incorporated by reference, teaches a system that combines voice recognition with optical character recognition (OCR) of a scanned image of the object being processed.

Various disclosed embodiments achieve a higher read rate and accuracy can be obtained than other technologies can produce individually by building on and expanding from a combination of earlier techniques.

FIG. 5 shows the operator 501 voicing the address for object 508 and a voice recognition result is determined the same as in the system of FIG. 2. In this case, a video image is captured and the voice result is used to focus an OCR process on a list of voice-result candidates weighted by correlation value. By using the techniques described above with regard to training and dialect clustering, the system in FIG. 4 is significantly improved.

FIG. 5 depicts a block diagram of a voice recognition process that generally corresponds to the process of FIG. 2, with the additional processes that the voice result 515 is used to focus an OCR process 523 on a list of candidates weighted by correlation value. In this process, a user or operator 501 voices the address of object 507 into a microphone of a computer 500 that can be implemented as one or more data processing systems 100. The computer uses the pre-defined voice attributes 503 stored in a database 505, that can be stored, for example, in a storage 126. The pre-defined voice attributes 503 can include generic attributes and can include user-specific voice attributes if training processes have been performed as described herein.

The extracted voice attributes 503 are compared, by this or another data processing system 100, to these predefined generic attributes 513 and a best match is calculated, as illustrated by compare process 509, to produce address result 515 that includes voice attribute data specific to that user. Typically a correlation value will be calculated that indicates how closely the voice attributes matched the pre-defined attributes. If the correlation value is above a pre-selected threshold value, the address result 515 will be passed to an OCR process 523.

The OCR process 523 can be performed using the computer 500, and automatically uses the recognized text of a scanned image of the address information of object 507. The OCR process combines the recognized text with the address result 515 from the voice-recognition process, and associates the OCR result with the corresponding voice attributes to produce a final combined OCR result 525.

In some embodiments, if the final combined OCR result 525 meets a predetermined confidence value threshold, it is passed to the sort control 217 and the object will be sorted according to a sort plan. If the threshold confidence value is not met, the combined result is rejected and the object can be handled by an exception process. In other embodiments, the combined OCR result can be passed to the sort control 217 without regard to any correlation threshold. The confidence value indicates the likelihood that the OCR process has correctly recognizes the text of the scanned image.

In applications such as sorting parcels in a postal environment the logistics of training an operator can be problematic due to large workforces that vary in composition daily. Managing a large ever-changing training database can be a significant challenge and, in many instances, may not be practical.

In various embodiments, the system of FIG. 5 also performs an online training process concurrently with the OCR—voice process. While the operators 501 are performing the processes of reading the object 507 so that the voice recognition, OCR, and other processes, the system is also trained according to the OCR results and corresponding voice attributes, which are sent to and stored in database 505 as training data 527. The lexicon in database 505 is created with the measured attributes for each operator. Database 505 can store voice attributes, corresponding OCR results, and training values for any number of users, along with other data.

The operator 501 performs a sort operation and voices the object 507 data of the FIG. 5. When an OCR result 527 has a high correlation value it is assumed the voice attributes has a high probability of being for that particular grammar item. The system then adjusts these parameters in the database 505 just as if the new data had been generated in a training session the same, as shown in FIG. 2, shown as the address result also being stored in database 505 in these cases. After the OCR process is performed, the training data 527 including corresponding voice attributes and OCR results can be stored in database 505, while the final combined OCR result 525 is used to sort the object 507 by the sort process 517.

As more and more objects are processed, the database 505 shown in FIG. 5 for the current operator will improve and the performance of the system will approach that of a system created with offline training without the logistical problems of offline training to create an operator database.

In an exemplary implementation such as a postal processing system, operators can process over one thousand objects per hour and the database will adapt very quickly. Because the operator typically works for an eight-hour shift a large percentage of the items will be processed with an optimized database.

For a dialect-based system such as that described by Kim, the OCR feedback can aid greatly in determining the best fit for the current operator. An example of this is the pronunciation of the state “Louisiana”. In some dialects the first four letters are pronounced “la-weez” and in others pronounced “loos”. By processing the spoken word into phonemes and state sequence the system chooses the dialect according to the best fit. Using high correlation OCR results the process can focus on known grammar items. It can be determined which cluster fits best with the current operator and a weighted list can be used to optimize the comparisons based upon the number of hits for a given cluster. By using data with a high OCR correlation level the cluster determination is statistically much more relevant than if done with uncorrelated data.

Another aspect of various embodiments is the ability of the system to adapt to the operator on a session-by-session basis. It is well known that people's voice characteristics can vary based upon health such as having a cold, stress, fatigue and other reasons. In a voice-only recognition system implemented with offline training it is not practical to adapt daily thus results will vary as the operator's condition changes relative to the condition at the time of training.

In an OCR—Voice system created with offline training, online OCR feedback training can be used to make adjustments on a daily basis. In this case the system can either save the modified data or start over with the offline training baseline in the next session.

In some embodiments, the database attributes for operators can be stored after they are created in a given online session. An operator identification system can be established and each operator identifies him or her self at the beginning of a session. The system then retrieves the data and begins with the last saved attribute set as the new baseline.

In some embodiments, the system can save the various attribute sets and then, rather than using overt operator identification, the system would search the sets for the best attribute match to the current user using the correlated OCR data to direct the search.

In some cases, an unknown operator, for whom an uncorrelated training data set exists, begins a sort operation without explicit identification, and the system then correlates that training data set. As the operator makes initial untrained utterances coincident with operation, the system correlates those to OCR data as usual, but puts a reliance on the OCR data than on the voice input data, and also uses the variation between voice recognition and OCR as a biometric indicator of phonetic dialect, so that the system can automatically select the appropriate training data set. As the system selects an appropriate training data set for the operator, the balance of confidence between OCR and Voice is adjusted accordingly.

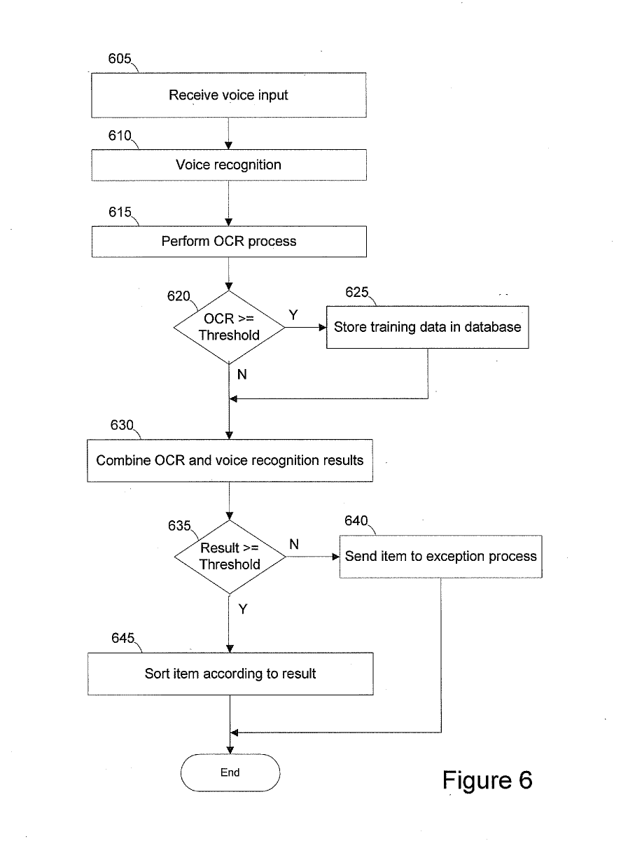

FIG. 6 depicts a flowchart of a process in accordance with disclosed embodiments. This process can be performed by any number of systems, including a mail processing system having at least one processor, a microphone, and a storage device storing a database, for example as one or more data processing systems 100.

The system receives a voice input from a user that corresponds to printed information on a mail piece (step 605). This step can and preferably does include receiving user identification and/or authentication.

The system performs a voice recognition process on the voice input (step 610), including comparing the voice input to voice attributes loaded or received from a database, to produce a voice address result. The voice attributes can be user-specific, if the user identification has been received, or generic.

The system performs an OCR process on an image of the printed information to produce recognized text (step 615). The OCR process also produces a confidence value that reflects the likelihood that the text of the printed information was correctly recognized.

In some cases, if the OCR result has a confidence value above a predetermined threshold (step 620), the system can store updated training data in the database (step 625). In these cases, and as part of this step, where there is a high likelihood that the OCR result is correct, the OCR result can be used as training data to associate with the voice input to produce updated voice attributes. This training data, including the updated voice attributes, corresponds to the voice input and recognized text and can be used as part of the voice recognition process as voice attributes for subsequent mail pieces. In this way, the system is constantly being trained as the mail pieces are being processed, and the updated voice attributes improve the data processing system's ability to recognize the user's voice input.

In preferred embodiments, the threshold confidence value may be relatively high, such as 98%. When there is a high confidence value in the recognized text, the voice recognition can be trained during the sort process with the same effectiveness as off-line training where the text being spoken is already known to the system. Where the OCR confidence value does not meet this threshold, the OCR result and voice recognition results may still be usable for the sorting process, as described below, even if they are not used as training data for updated voice attributes. In other embodiments, step 620 can be omitted, and step 625 can be either performed in every instance or can be omitted.

The system combines the recognized text and the voice address result to produce a combined OCR result (step 630).

If the combined OCR result has a correlation value above a second predetermined threshold (step 635), the system sends the combined OCR result to a sorting system that sorts the mail piece according to the combined OCR result (step 645), and this portion of the mail sorting process ends. This step can also include labeling the mail piece with a sort indicia corresponding to the combined OCR result, including by directly printing the indicia on the mail piece, affixing the mail piece with a label that includes the indicia, or placing the mail piece in a carrier that includes the indicia. If the combined OCR result does not have a correlation value that meets the second, predetermined threshold (at step 635) the item can be sent to an exception process (step 640) for manual or other processing as this portion of the mail sorting process ends.

The second predetermined threshold may be a value such as 80%, indicating that if there is an 80% correlation between the recognized voice input and the OCR result, then the combined OCR result can be used for the sorting process. The sorting process can have lower requirements than the training process; for example, if the OCR result has only a 90% confidence value, then it may not be usable for training, but if the correlation between the OCR result and the recognized voice input is 85%, then the combined OCR result can still be used for sorting.

It is important to note that while the disclosure includes a description in the context of a fully functional system, those skilled in the art will appreciate that at least portions of the mechanism of the present disclosure are capable of being distributed in the form of a computer-executable instructions contained within a machine-usable, computer-usable, or computer-readable medium in any of a variety of forms to cause a system to perform processes as disclosed herein, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs). In particular, computer readable mediums can include transitory and non-transitory mediums, unless otherwise limited in the claims appended hereto.

Although an exemplary embodiment of the present disclosure has been described in detail, those skilled in the art will understand that various changes, substitutions, variations, and improvements disclosed herein may be made without departing from the spirit and scope of the disclosure in its broadest form. In the processes described above, various steps may be performed sequentially, concurrently, in a different order, or omitted, unless specifically described otherwise.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method for delivery route assistance, the method comprising:
receiving in a data processing system a voice input from a user, the voice input corresponding to printed information on a mail piece;
performing a voice recognition process on the voice input to produce a voice address result, the voice recognition process using voice attributes from a database;
performing an optical character recognition (OCR) process on an image of the printed information to produce recognized text and a confidence value;
when the confidence value meets a first threshold, then storing updated voice attributes corresponding to the voice input and recognized text in the database;
combining the recognized text and the voice address result to produce a combined OCR result; and
sending the combined OCR result to a sorting system that sorts the mail piece according to the combined OCR result.

2. The method of claim 1, wherein the first threshold represents a 98% likelihood that the recognized text accurately represent the printed information.

3. The method of claim 1, further comprising receiving a user identification.

4. The method of claim 1, wherein the voice attributes correspond to a user identification of the user.

5. The method of claim 1, wherein the stored updated voice attributes correspond to a user identification of the user.

6. The method of claim 1, wherein the stored updated voice attributes improve the data processing system's ability to recognize the user's voice input.

7. The method of claim 1, wherein the stored updated voice attributes are used to for a voice recognition process for a subsequent mail piece.

8. The method of claim 1, wherein the mail price is labeled with a sort indicia corresponding to the combined OCR result.

9. The method of claim 1, wherein if the user is not identified, then the combining process uses a higher reliance on the recognized text than on the voice address result.

10. The method of claim 1, wherein a variation between the voice address result and the recognized text is used as a biometric indicator of phonetic dialect.

11. A mail processing system, comprising:
at least one processor;
a microphone; and
a storage device storing a database, the mail processing system configured to perform the processes of:
receiving in a data processing system a voice input from a user, the voice input corresponding to printed information on a mail piece;
performing a voice recognition process on the voice input to produce a voice address result, the voice recognition process using voice attributes from a database;
performing an optical character recognition (OCR) process on an image of the printed information to produce recognized text and a confidence value;
when the confidence value meets a first threshold, then storing updated voice attributes corresponding to the voice input and recognized text in the database;
combining the recognized text and the voice address result to produce a combined OCR result; and
sending the combined OCR result to a sorting system that sorts the mail piece according to the combined OCR result.

12. The mail processing system of claim 11, wherein the first threshold represents a 98% likelihood that the recognized text accurately represent the printed information.

13. The mail processing system of claim 11, further configured to perform the process of receiving a user identification.

14. The mail processing system of claim 11, wherein the voice attributes correspond to a user identification of the user.

15. The mail processing system of claim 11, wherein the stored updated voice attributes correspond to a user identification of the user.

16. The mail processing system of claim 11, wherein the stored updated voice attributes improve the data processing system's ability to recognize the user's voice input.

17. The mail processing system of claim 11, wherein the stored updated voice attributes are used to for a voice recognition process for a subsequent mail piece.

18. The mail processing system of claim 11, wherein the mail price is labeled with a sort indicia corresponding to the combined OCR result.

19. The mail processing system of claim 11, wherein if the user is not identified, then the combining process uses a higher reliance on the recognized text than on the voice address result.

20. The mail processing system of claim 11, wherein a variation between the voice address result and the recognized text is used as a biometric indicator of phonetic dialect.
